(19) United States
(12) Patent Application Publication
(10) Pub. No.: US 2017/0168214 A1
(43) Pub. Date: Jun. 15, 2017

(54) LIGHT GUIDE PLATE AND BACK LIGHT MODULE

(71) Applicants: Shenzhen China Star Optoelectronics Technology Co. Ltd., Shenzhen, Guangdong (CN); WUHAN CHINA STAR OPTOELECTRONICS TECHNOLOGY CO. LTD., Wuhan, Hubei (CN)

(72) Inventor: Yan CHENG, Shenzhen, Guangdong (CN)

(73) Assignees: Shenzhen China Star Optoelectronics Technology Co. Ltd., Shenzhen, Guangdong (CN); WUHAN CHINA STAR OPTOELECTRONICS TECHNOLOGY CO. LTD., Wuhan, Hubei (CN)

(21) Appl. No.: 14/909,100

(22) PCT Filed: Sep. 10, 2015
(86) PCT No.: PCT/CN2015/089391

§ 371 Date: Jan. 29, 2016

(30) Foreign Application Priority Data
Aug. 12, 2015 (CN) 201510492762.2

(51) Int. Cl. F21V 8/00; G02F 1/1335

(52) U.S. Cl. CPC G02B 6/0016; G02B 6/0053; G02B 6/0003; G02F 1/133504; G02F 2001/133507

(57) ABSTRACT

The present disclosure discloses a liquid crystal display driving device, including a time sequence controller, a data and scan drivers, a liquid display panel and a programmable gamma circuit connected to the data driver. The time sequence controller is respectively connected to the data and scan drivers. The data driver coverts an image data to an analog voltage. The programmable gamma circuit outputs a reference voltage to the data driver and used to assign the reference voltage in real time. The reference voltage corrects the analog voltage so the data driver outputs a gray-level voltage to a liquid crystal unit opened by the scan driver to display an image frame or a black frame. It overcome a problem of overlapping a left-eye and right-eye image frames and at the same time greatly decreases a power consumption of a system. The present disclosure also discloses a liquid crystal display driving method.

### CROSS-REFERENCE TO RELATED APPLICATIONS

This application claims the priority of Chinese Patent Application No. 201510492762.2, entitled “liquid crystal display driving device and liquid crystal display driving method”, filed on Aug. 12, 2015, the disclosure of which is incorporated herein by reference in its entirety.

### FIELD OF THE INVENTION

The present disclosure relates to a display technology field, and more particularly to a light guide plate and a back light module.

### BACKGROUND OF THE INVENTION

Currently, in the market a gamut level of a major liquid crystal display element (including flat panel display) is about 72% and even lower. To increase the gamut, a quantum dot (QD) back light technology is proposed accordingly, so the gamut level of the display product is increased to 100% to greatly enriched the performance capabilities of the display product. However, employing the QD back light module has a larger inside chromatic aberration since quantum dots are not uniformly formed on a film or a difference is existed between the excitation efficiencies of the file edge and the central quantum dot. At the same time, the quantum docs are farther away from a light source so a light throughput efficiency is quite low to cause a low brightness of the entire module.

Therefore, it is necessary to improve the prior art to increase an uniformity of color of the product.

### SUMMARY OF THE INVENTION

The technology problem solved by the present disclosure is to provide a light guide plate and a back light module to increase an uniformity of color.

To achieve the foregoing goal, the embodiment of the present disclosure employs following solution:

In one facet, the light guide plate is provided and comprises a light-emitting face, a bottom face, a first side face and a second side face. The first and second side faces are formed oppositely and connected between the light-emitting face and the bottom face. The fluorescence layer is formed on the light-emitting face and comprises multiple micro-structures arranged in parallel, wherein an inner package of the micro-structure comprises multiple quantum dots. The micro-structure comprises a micro-structural-light-incident face formed on the light-emitting face, wherein a middle part of the micro-structure is thicker than two edge parts of the micro-structure along a direction being perpendicular to the micro-structural-light-incident face.

Specifically, the first side face is the light-incident face of the body and a light-incident direction of the body is perpendicular to a light-emitting direction of the body, and along the light-incident direction of the body, a size range of the light-incident face of the micro-structure is about 25 to 75 um.

Specifically, a reflection layer is formed on the second side face.

Specifically, the micro-structures are extended along the direction being perpendicular to the light-incident direction of the body.

Specifically, the micro-structures are continuously arranged along the light-incident direction of the body.

Specifically, the micro-structure is a shape of triangular prism.

In another facet, the back light module is also provided and comprises a first light source and a light guide plate, wherein the light guide plate comprises a body and a fluorescence layer, wherein the body comprises a light-emitting face, a bottom face, a first side face and a second side face, wherein the first and second side faces are formed oppositely and connected between the light-emitting face and the bottom face, the first light source is next to the first side face, the fluorescence layer is formed on the light-emitting face. The fluorescence layer comprises multiple micro-structures arranged in parallel, wherein an inner package of the micro-structure comprises multiple quantum dots and the micro-structure comprises a micro-structural-light-incident face formed on the light-emitting face, wherein a middle part of the micro-structure is thicker than two edge parts of the micro-structure along a direction being perpendicular to the micro-structural-light-incident face.

Specifically, the first side face is the light-incident face of the body and a light-incident direction of the body is perpendicular to a light-emitting direction of the body, and along the light-incident direction of the body, a size range of the light-incident face of the micro-structure is about 25 to 75 um.

Specifically, a reflection layer is formed on the second side face.

Specifically, the micro-structures are extended along the direction being perpendicular to the light-incident direction of the body.

Specifically, the micro-structures are continuously arranged along the light-incident direction of the body.

Specifically, the micro-structure is a shape of triangular prism.

Specifically, the light guide plate comprises two bodies, wherein a reflection layer is formed on the second side face of each body, the two reflection layer are attached to each other, the two light-emitting faces of the two bodies are coplanar, the two bottom faces of the two bodies are coplanar, the fluorescence layer is formed to cover the two light-emitting faces of the two bodies; and the light guide plate further comprises a second light source and the first and second light sources are formed oppositely and respectively located two sides of the light guide plate.

Specifically, an adhesive layer is formed between the reflection layer and the two reflection layers.

Specifically, a reflection plate is formed on the bottom face of the light guide plate.

In comparison with the prior art, the present disclosure has following advantages.

The present disclosure packages the quantum dots in the micro-structures. On a plane where the micro-structural-light-incident face is, a distance between the adjacent micro-structures is only 25 um to 75 um. Since a size of the micro-structure 12 is small, a species and a proportion of the quantum dots 11 in the inner package are easily arranged and controlled. The entire fluorescence layer 1 is composed of the micro-structures 12 regularly arranged to greatly increase an uniformity of light-emitting color of the light guide plate. Furthermore, along the direction being perpendicular to the micro-structural-light-incident face, the micro-structure with a cross-sectional shape having a thinker middle part and two thinner edge parts to condense lights to increase a brightness of the light guide plate.

The assignment of the light guide plate increases a brightness and an uniformity of light-emitting color of the back light module employing the light guide plate and the back light module has a better display quality.

Furthermore, Since lights from the light source are emitted to the body of the light guide plate through the light-incident face, and then emitted to the fluorescence layer from the light-emitting face of the body of the light guide plate and further converted to different lights with different wavelengths after passing through the quantum dots. The reflection plate reflects lights from the bottom face to the body of the light guide plate and the reflection layer is used to reflect lights from the second side face to the body of the light guide plate, so the lights can be taken twice to increase and efficiency of the lights. After the lights are reflected, the fluorescence layer is repeatedly excited to increase a light-emitting efficiency of the quantum dot 11 and to further increase a brightness of the back light module.

### BRIEF DESCRIPTION OF THE DRAWINGS

In order to more clearly illustrate the embodiments of the present disclosure or prior art, the following figures will be described in the embodiments are briefly introduced. It is obvious that the drawings are merely some embodiments of the present disclosure, those of ordinary skill in this field can obtain other figures according to these figures without paying the premise.

FIG. 1 is a structural schematic drawing of a light guide plate of an embodiment of the present disclosure;

FIG. 2 is an enlarged view of a part of FIG. 1 pointed by a reference number “A”;

FIG. 3 is a structural schematic drawing of a back light module of an embodiment of the present disclosure;

FIG. 4 is a structural schematic drawing of another back light module of an embodiment of the present disclosure; and

FIG. 5 is an enlarged view of a part of FIG. 4 pointed by a reference number “B”.

### DETAILED DESCRIPTION OF THE PREFERRED EMBODIMENTS

Embodiments of the present disclosure are distinctly and completely described in detail with the technical matters with reference to the accompanying drawings as follows.

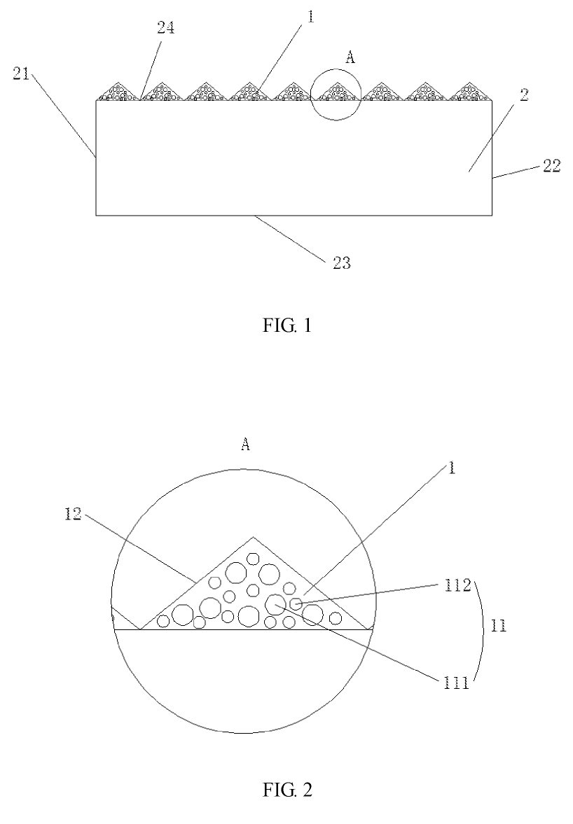

Please refer to FIG. 1 and FIG. 2. FIG. 1 is a structural schematic drawing of a light guide plate of an embodiment of the present disclosure. FIG. 2 is an enlarged view of a part of FIG. 1 pointed by a reference number “A”. The embodiment of the present disclosure provides the light guide plate, as shown in FIG. 1, the light guide plate comprises a body 2 and a fluorescence layer 1. The body 2 has a light-emitting face 24, a bottom face 23, a first side face 21 and a second side face 22. The first and second side faces 21, 22 are formed oppositely and connected between the light-emitting face 24 and the bottom face 23. The fluorescence layer 1 is formed on the light-emitting face 24.

The fluorescence layer 1 comprises multiple micro-structures 12 arranged in parallel. As shown in FIG. 2, an inner package of the micro-structure has multiple quantum dots and the micro-structure 12 has a micro-structural-light-incident face formed on the light-emitting face 24. A middle part of the micro-structure 12 is thicker than two edge parts of the micro-structure 12 along a direction being perpendicular to the micro-structural-light-incident face. It can understand that “the thicker middle part and two thinner edge parts” means that along the direction being perpendicular to the micro-structural-light-incident face, a distance between a top of the middle part of the micro-structure and the micro-structural-light-incident face is longer than a distance between a top of the edge part and the micro-structural-light-incident face. This structure can condense lights to increase a brightness of the light guide plate.

As shown in FIG. 2, the quantum dots 11 in the inner package of the micro-structure 12 includes large quantum dots 112 and small quantum dots 111. An emission spectrum of the quantum dot is controlled by changing sizes of the quantum dot 11. The size of the quantum dot 11 is changed to allow that the emission spectrum thereof covers a visible spectral range. Therefore, An arrangement and distribution of the large and small quantum dots directly effect a light emitting quality. The embodiment of the present disclosure respectively packages the quantum dots 11 in the micro-structures 12. Since a size of the micro-structure 12 is small, a species and a proportion of the quantum dots 11 are easily arranged and controlled. The entire fluorescence layer 1 is composed of the micro-structures 12 regularly arranged to greatly increase an uniformity of light-emitting color of the light guide plate and the light guide plate can have a better display quality.

Furthermore, the first side face 21 of the body 2 is the light-incident face of the body 2 and a light-incident direction of the body 2 is perpendicular to a light-emitting direction of the body 2. Along the light-incident direction of the body 2, a size range of the light-incident face of the micro-structure 12 is about 25 to 75 um. The micro-structure 12 with micron size further ensures that the uniformity of the light-emitting color of the light guide plate.

In the preferred embodiment of the present disclosure, a reflection layer is formed on the second side face 22 of the body 2. the reflection layer is used to reflect lights from the second side face 22 to the body 2, so the lights can be taken twice to increase and efficiency of the lights. After the lights are reflected, the fluorescence layer 1 is repeatedly excited to increase a light-emitting efficiency of the quantum dot 11 and to further increase the brightness of the light guide plate. Furthermore, a material of a first reflection layer is selected from Silver or Barium sulfate etc. material with a light-reflection function.

In another preferred embodiment of the present disclosure, the micro-structures 12 are extended along the direction being perpendicular to the light-incident direction of the body 2. Furthermore, the micro-structures 12 are continuously arranged on the light-incident direction of the body 12.

In another preferred embodiment of the present disclosure, the micro-structure 12 is a shape of triangular prism. One side of the triangular prism is used as a light-incident face of the micro-structure 12. It can understand that the micro-structure 12 may be a structure with a cross-sectional shape having a thinker middle part and two thinner edge parts, such as half-cylinder or a trapezoid body etc. Any modification, equivalent replacement and improvement, etc. within the spirit and principles of the present disclosure should be included within the scope of the present disclosure.

In the embodiment of the present disclosure, a material of the package of the micro-structure 12 may be made of silica gel or other transparent material, which has a function of water-proof and a function of oxygen-proof to protect the quantum dots 11. Any modification, equivalent replacement and improvement, etc. within the spirit and principles of the present disclosure should be included within the scope of the present disclosure.

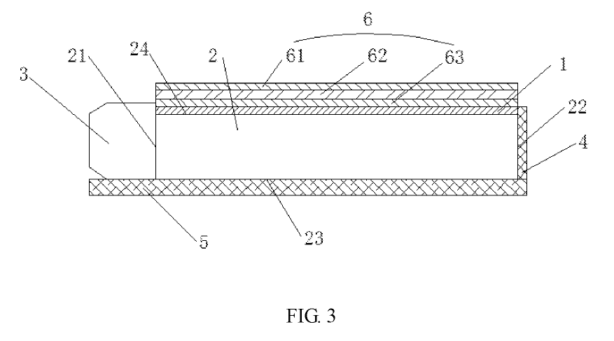

Please refer to FIG. 3. FIG. 3 a structural schematic drawing of a back light module of an embodiment of the present disclosure. The embodiment of the present disclosure provides the back light module comprising a light guide plate, a first light source 3 and a reflection plate 5. Wherein, the light guide plate comprises a body 2 and a fluorescence layer 1. The body 2 has a light-emitting face 24, a bottom face 23, a first side face 21 and a second side face 22. The first and second side faces 21, 22 are formed oppositely and connected between the light-emitting face 24 and the bottom face 23. The fluorescence layer 1 is formed on the light-emitting face 24. The first light source 3 is next to the first side face 21, a reflection layer 4 spread on the second side face 22 and the flection plate 5 is attached to the bottom face 23. A disposition of the fluorescence layer 1 is the same as that of the previous embodiment, so the details thereof are not described here.

It can understand that in the embodiment of the present disclosure, lights from the first light source 3 are emitted to the body 2 of the light guide plate through the first side face 21 and then emitted to the fluorescence layer 1 from the light-emitting face 24. The lights emitted from the first light source 3 are further converted to different lights with different wavelengths after passing through the quantum dots 11. The reflection plate 5 reflects lights from the bottom face 23 to the body 2 and the reflection layer 4 is used to reflect lights from the second side face 22 to the body 2, so the lights can be taken twice to increase and efficiency of the lights. After the lights are reflected, the fluorescence layer 1 is repeatedly excited to increase a light-emitting efficiency of the quantum dot 11 and to further increase a brightness of the back light module.

Furthermore, since the back light module employs the fluorescence layer 1 of the foregoing embodiment, a deposition of a structure of the fluorescence layer 1 increases a brightness and uniformity of a light-emitting color of the back light module. The back light module has a better display quality.

In another embodiment of the present disclosure, the first light source 3 is a blue light emitting diode. However, it can understand that it may employ another light source as the first light source. Any modification, equivalent replacement and improvement, etc. within the spirit and principles of the present disclosure should be included within the scope of the present disclosure. In the present embodiment, the larger quantum dot 112 can convert the lights emitted from the standard blue light emitting diode to different lights with long wavelength (such as red lights). The small quantum dot 111 can convert the lights emitted from the standard blue light emitting diode to different lights with short wavelength (such as green lights). Different quantum dots 11 are mixed to form a new optical spectrum. Using the standard blue light emitting diode as the light source accomplishes trichromatic white lights. A display function of a display device using the back light module can achieve a new level.

In another preferred embodiment of the present disclosure, the back light module also comprises an optical film formed on a side of the light guide plate being depart from the reflection plate 5. The optical film 3 comprises a diffuser film 62 and also comprises a lower prismatic film 63 formed between the fluorescence layer 1 and the diffuser film 62 and an upper prismatic film 61 formed on a side of the diffuser film 62 departed from the lower prismatic film 63. The diffuser film 62 can distribute back lights uniformly and increase a light transmittance to have a high brightness. The upper and lower prismatic films 61, 63 can increase optical functions of the back light module.

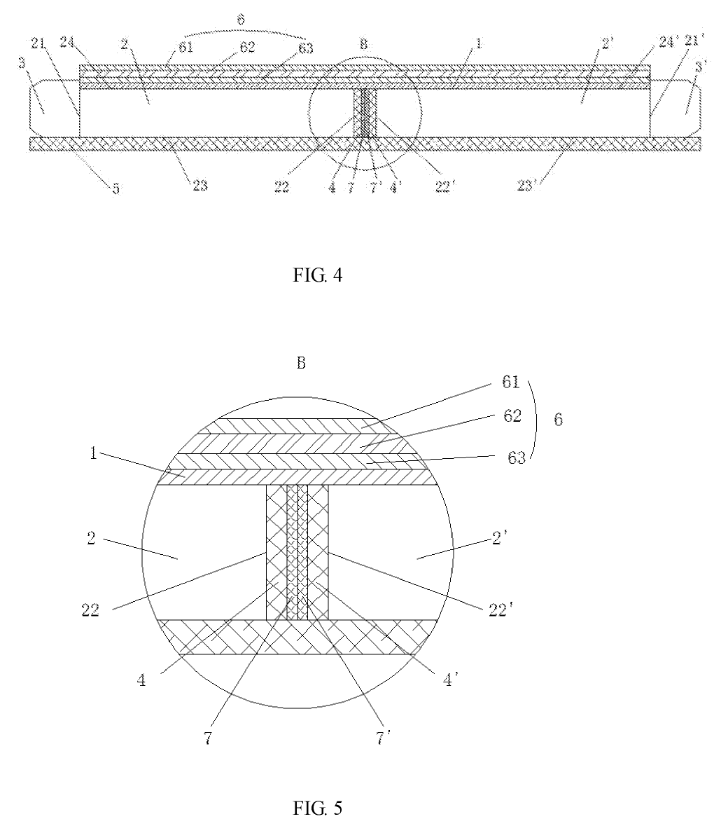

Please refer to FIG. 4 and FIG. 5. FIG. 4 is a structural schematic drawing of another back light module of an embodiment of the present disclosure and FIG. 5 is an enlarged view of a part of FIG. 4 pointed by a reference number “B”. The embodiment of the present disclosure provides another back light module. As shown in FIG. 4, the back light module comprises a light guide plate, a first light source 3, a second light source 3′ and a reflection plate 5. Wherein, the light guide plate comprises a first body 2, a second body 2′ and a fluorescence layer 1. The first body 2 has a light-emitting face A 24, a bottom face A 23, a first side face A 21 and a second side face A 22. The first side face A 21 and the second side face A 22 are formed oppositely and connected between the light-emitting face A 24 and the bottom face A23. The second body 2′ has a light-emitting face B 24′, a bottom face B 23′, a first side face B 21′ and a second side face B 22′. The first side face B 21′ and the second side face B 22′ are formed oppositely and connected between the light-emitting face B 24′ and the bottom face B 23′. A reflection layer A 4 and a reflection layer B 4′ are respectively spread on the second side face A 22 and the second side face B 22′. The reflection layer A 4 and the reflection layer B 4′ are attached to each other. The light-emitting face A 24 and the light emitting face B 24′ are coplanar. The bottom face A 23 and the bottom face B 23′ are coplanar. The fluorescence layer 1 is formed to cover the light-emitting face A 24 and the light emitting face B 24′. The first light source 3 and the second light source 3′ are formed oppositely and respectively located two sides of the light guide plate. The reflection plate 5 is mounted on the bottom face and is used to reflect lights from the bottom face A 23 and the bottom face B 23′ to the first body 2 and the second body 2′.

It can understand that in the embodiment of the present disclosure, the lights from the first light source 3 are emitted to the fluorescence layer 1 through the first side face A 21, the first body 2 and the light-emitting face A 24. The lights from the second light source 3′ are emitted to the fluorescence layer 1 through the first side face B 21′, the second body 2′ and the light-emitting face B 24′ to excite the quantum dots 11 to emit different lights with different wavelengths. The reflection layer A 4 is used to reflect the lights from the second side face A 22 to the first body 2 and the reflection layer B 4′ is used to reflect the lights from the second side face B 22′ to the second body 2′. Thus the lights can be taken twice to increase and efficiency of the lights. After the lights are reflected, the fluorescence layer 1 is repeatedly excited to increase a light-emitting efficiency of the quantum dot 11 and to further increase a brightness of the back light module.

Furthermore, since the back light module employs the fluorescence layer 1 of the foregoing embodiment, a deposition of a structure of the fluorescence layer 1 increases a brightness and uniformity of a light-emitting color of the back light module. The back light module has a better display quality.

In the preferred embodiment of the present disclosure, as shown in FIG. 5, an adhesive layer is formed between the reflection layer A 4 and the reflection layer B 4′ and used to adhere the first body 2 to the second body 2′. It can understand that the adhesive layer may be a single layer or may be composed of an adhesive layer A 7 spread on the reflection layer A 4 and an adhesive layer B 7′ spread on the reflection layer B 4′.

In another embodiment of the present disclosure, the first light source 3 and the second light source 3′ are the blue light emitting diodes. However, it can understand that they may employ other light sources as the first and second light sources.

In another preferred embodiment of the present disclosure, the back light module also comprises an optical film formed on a side of the light guide plate being depart from the reflection plate 5. The optical film 3 comprises a diffuser film 62 and also comprises a lower prismatic film 63 formed between the fluorescence layer 1 and the diffuser film 62 and an upper prismatic film 61 formed on a side of the diffuser film 62 being depart from the lower prismatic film 63. The diffuser film 62 can distribute back lights uniformly and increase a light transmittance to have high brightness. The upper and lower prismatic films 61, 63 can increase optical functions of the back light module.

The above embodiments of the present disclosure are preferred embodiments. It should be noted that people who skilled in the filed make improvements and polishes within the principles of the present disclosure and these improvements and polishes should be covered in the scope of the present disclosure.

What is claimed is:

1. A light guide plate, comprising a body and a fluorescence layer;
wherein the body comprises a light-emitting face, a bottom face, a first side face and a second side face, wherein the first and second side faces are formed oppositely and connected between the light-emitting face and the bottom face; and the fluorescence layer is formed on the light-emitting face and comprises multiple micro-structures arranged in parallel, wherein an inner package of the micro-structure comprises multiple quantum dots and the micro-structure comprises a micro-structural-light-incident face formed on the light-emitting face, wherein a middle part of the micro-structure is thicker than two edge parts of the micro-structure along a direction being perpendicular to the micro-structural-light-incident face.

2. The light guide plate according to claim 1, wherein the first side face is the light-incident face of the body and a light-incident direction of the body is perpendicular to a light-emitting direction of the body, and along the light-incident direction of the body, a size range of the light-incident face of the micro-structure is about 25 to 75 um.

3. The light guide plate according to claim 2, wherein a reflection layer is formed on the second side face.

4. The light guide plate according to claim 3, wherein the micro-structures are extended along the direction being perpendicular to the light-incident direction of the body.

5. The light guide plate according to claim 4, wherein the micro-structures are continuously arranged along the light-incident direction of the body.

6. The light guide plate according to claim 5, wherein the micro-structure is a shape of triangular prism.

7. A back light module, comprising a first light source and a light guide plate, wherein the light guide plate comprises a body and a fluorescence layer, wherein the body comprises a light-emitting face, a bottom face, a first side face and a second side face, wherein the first and second side faces are formed oppositely and connected between the light-emitting face and the bottom face, the first light source is next to the first side face, the fluorescence layer is formed on the light-emitting face; and the fluorescence layer comprises multiple micro-structures arranged in parallel, wherein an inner package of the micro-structure comprises multiple quantum dots and the micro-structure comprises a micro-structural-light-incident face formed on the light-emitting face, wherein a middle part of the micro-structure is thicker than two edge parts of the micro-structure along a direction being perpendicular to the micro-structural-light-incident face.

8. The back light module according to claim 7, wherein the first side face is the light-incident face of the body and a light-incident direction of the body is perpendicular to a light-emitting direction of the body, and along the light-incident direction of the body, a size range of the light-incident face of the micro-structure is about 25 to 75 um.

9. The back light module according to claim 8, wherein a reflection layer is formed on the second side face.

10. The back light module according to claim 9, wherein the micro-structures are extended along the direction being perpendicular to the light-incident direction of the body.

11. The back light module according to claim 10, wherein the micro-structures are continuously arranged along the light-incident direction of the body.

12. The back light module according to claim 11, wherein the micro-structure is a shape of triangular prism.

13. The back light module according to claim 7, wherein the light guide plate comprises two bodies, wherein a reflection layer is formed on the second side face of each body, the two reflection layer are attached to each other, the two light-emitting faces of the two bodies are coplanar, the two bottom faces of the two bodies are coplanar, the fluorescence layer is formed to cover the two light-emitting faces of the two bodies; and the light guide plate further comprises a second light source and the first and second light sources are formed oppositely and respectively located two sides of the light guide plate.

14. The back light module according to claim 8, wherein an adhesive layer is formed between the reflection layer and the two reflection layers.

15. The back light module according to claim 9, wherein a reflection plate is formed on the bottom face of the light guide plate.
